(19) United States
(12) Patent Application Publication
(10) Pub. No.: US 2026/0312523 A1
(43) Pub. Date: Oct. 8, 2026

(54) SEMICONDUCTOR DEVICE

(71) Applicant: Renesas Electronics Corporation, Tokyo (JP)

(72) Inventor: Yo WATAMURA, Tokyo (JP)

(21) Appl. No.: 19/558,845

(22) Filed: Mar. 6, 2026

(30) Foreign Application Priority Data
Apr. 4, 2025 (JP) 2025-062726

(51) Int. Cl. H02P 23/14; H02P 5/74

(52) U.S. Cl. CPC H02P 23/14; H02P 5/74; H02P 2203/03; H02P 2205/01

(57) ABSTRACT

In this semiconductor device, an AD converter detects a current value supplied from an inverter to a motor. A rotational angle acquisition circuit acquires an angular position of a rotor from an encoder of the motor. A processor generates a current control signal by performing a computation based on a current value detected by the AD converter and an angular position acquired most recently. A PWM timer generates a PWM signal based on the current control signal and outputs it to the inverter. The processor performs, in one period of a PWM carrier signal, processing to cause the AD converter to start detection of the current value, processing to start the computation in response to an end of the detection of the current value, and processing to cause the rotational angle acquisition circuit to start acquisition of the angular position in response to execution of the computation.

### CROSS-REFERENCE TO RELATED APPLICATIONS

The disclosure of Japanese Patent Application No. 2025-062726 filed on Apr. 4, 2025 including the specification, drawings and abstract is incorporated herein by reference in its entirety.

### BACKGROUND

The present invention relates to a semiconductor device.

The following technique is known.

### [Patent Document 1] Japanese Unexamined Patent Application Publication No. 2022-57101

Conventionally, a technique for controlling a motor using a semiconductor device is known. For example, Patent Document 1 describes a semiconductor device for controlling a motor. The semiconductor device performs computations using a current value supplied from an inverter to a motor and an angular position of a motor rotor, and performs PWM (Pulse Width Modulation) control of the inverter based on the computation result.

### SUMMARY

The semiconductor device receives a signal from an encoder electrically connected to a motor to acquire an angular position. Since transmission of signals from the encoder takes a relatively long time, there is a difference between the angular position acquired by the semiconductor device and an actual angular position at the time when the semiconductor device performs the above computation. Due to the influence of this difference, an error occurs in the computation result, and the accuracy of control of the current supplied to the motor decreases.

Under the circumstances described above, there is a demand for a semiconductor device that suppresses a decrease in the accuracy of control of current supplied to a motor.

Other problems and novel features will become apparent from description of this specification and the accompanying drawings.

A semiconductor device according to one embodiment includes a first AD converter, a first rotational angle acquisition circuit, a first PWM timer, and a processor. The first AD converter detects a first current value supplied from a first inverter to a first motor. The first rotational angle acquisition circuit acquires a first angular position of a rotor of the first motor from a first encoder electrically connected to the first motor. The processor generates a first current control signal by performing a first computation based on the first current value detected by the first AD converter and a first angular position acquired most recently. The first PWM timer includes a first counter, and the first PWM timer generates a first PWM signal using a modulated wave based on the first current control signal and a first carrier signal defined by a value of the first counter, and then outputs the first PWM signal to the first inverter. The processor performs, in one period of the first carrier signal, (a) processing to cause the first AD converter to start detection of the first current value, (b) processing to start the first computation in response to an end of the detection of the first current value, and (c) processing to cause the first rotational angle acquisition circuit to start acquisition of the first angular position in response to the execution of the first computation.

A semiconductor device according to another embodiment includes N sets, each set including an AD converter, a rotational angle acquisition circuit, and a PWM timer, where N is 3 or more and a processor. Each of the N sets corresponds to a respective one of N inverters and a respective one of N motors. The AD converter detects a current value supplied from a corresponding inverter to a corresponding motor. The rotational angle acquisition circuit acquires an angular position of a rotor of a corresponding motor from an encoder electrically connected to the corresponding motor. The processor generates a current control signal by performing a computation based on the current value detected by the AD converter and an angular position acquired most recently. The PWM timer includes a counter, and the PWM timer generates a PWM signal using a modulated wave based on the current control signal and a carrier signal defined by a value of the counter, and then outputs the PWM signal to the inverter. The processor performs, in one period of the carrier signal, (g) processing to cause the N AD converters to start detection of the current values supplied to the N motors, (h) processing to start the computation corresponding to a first motor in response to an end of the detection of the current values supplied to the N motors, and (i) processing to cause a first rotational angle acquisition circuit to start acquisition of the angular position from an encoder electrically connected to the first motor in response to execution of the computation corresponding to the first motor. Also, the processor repeatedly performs, in the one period and with k changing from 1 to N−1 in increments of 1, (j) processing to start the computation corresponding to a (k+1)-th motor in response to an end of the computation corresponding to a k-th motor and (k) processing to cause a (k+1)-th rotational angle acquisition circuit to start acquisition of the angular position from a (k+1)-th encoder in response to the execution of the computation corresponding to the (k+1)-th motor.

According to one embodiment, a semiconductor device that suppresses a decrease in the accuracy of control of current supplied to a motor is realized.

### BRIEF DESCRIPTION OF THE DRAWINGS

FIG. 1 is a diagram schematically illustrating a configuration of a motor control system according to an embodiment.

FIG. 2 is a diagram illustrating the configuration of the motor control system according to the embodiment in detail.

FIG. 3 is a configuration diagram of a current control system corresponding to one motor.

FIG. 4 is a time chart of current control processing corresponding to one motor.

FIG. 5 is a flowchart of processing related to control of one motor in an MCU.

FIG. 6 is a flowchart of current control processing corresponding to one motor.

FIG. 7 is a time chart of current control processing corresponding to two motors.

FIG. 8 is a flowchart of processing related to control of two motors in an MCU.

FIG. 9 is a time chart of current control processing corresponding to three or more motors.

FIG. 10 is a flowchart of processing related to control of three or more motors in an MCU.

FIG. 11 is a diagram illustrating results of comparison between a standard method and a proposed method with respect to a relationship between magnetic flux and current in motors.

FIG. 12 is a diagram illustrating a modification of the embodiment.

FIG. 13 is a diagram illustrating a configuration example of a motor control system that controls one motor.

FIG. 14 is a diagram illustrating a relationship among magnetic flux, current, and torque in a motor.

FIG. 15 is a diagram illustrating a time chart of each processing in control of one motor by a standard method.

FIG. 16 is a diagram illustrating a configuration example of a motor control system that controls three motors.

FIG. 17 is a diagram illustrating a time chart of each processing in control of three motors by a standard method.

FIG. 18 is a diagram for describing a shift of current with respect to magnetic flux in a motor.

### DETAILED DESCRIPTION

Hereinafter, embodiments will be described. First, the background of studies conducted by the present inventor will be described. Thereafter, embodiments of a semiconductor device proposed in the present application will be described.

In the following embodiments, the same or corresponding components are denoted by the same reference numerals, and repeated description thereof will be omitted unless necessary.

In the following embodiments, an MCU is an example of a “semiconductor device” in the present application. Also, a CPU is an example of a “processor” in the present application. Further, an encoder interface is an example of a “rotational angle acquisition circuit” according to the present application.

### Background of Studies Conducted by Present Inventor

The background of studies conducted by the present inventor will be described.

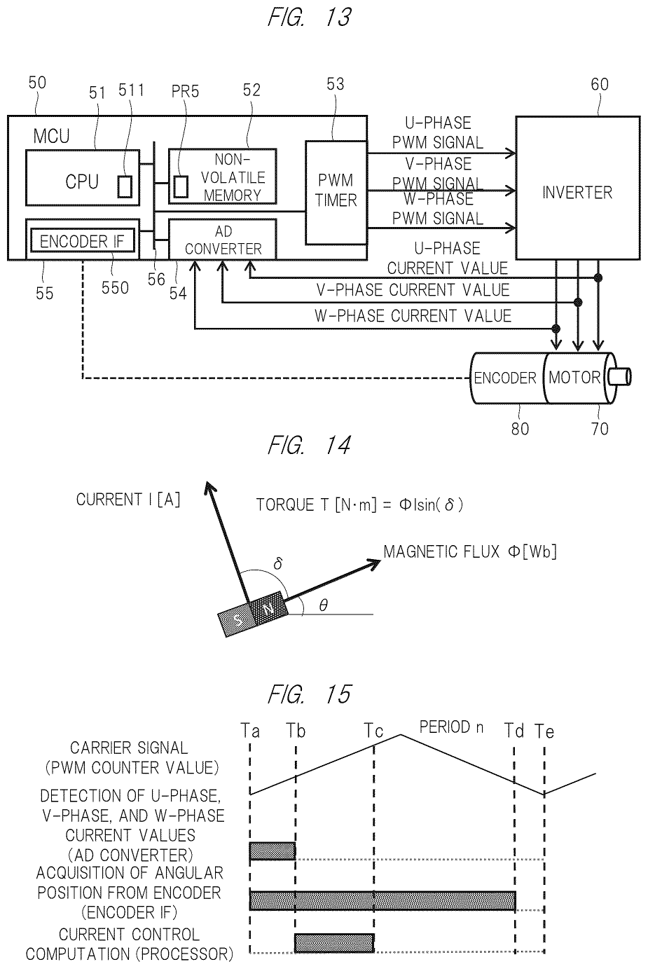

FIG. 13 is a diagram illustrating a configuration example of a motor control system that controls one motor. The motor control system includes, for example, an MCU (Microcontroller Unit) 50, an inverter 60, a motor 70, and an encoder 80 as illustrated in FIG. 13. The MCU 50 includes, for example, a CPU (Central Processing Unit) 51, a non-volatile memory 52, a PWM timer 53, an AD converter 54, a rotational angle acquisition circuit 55, and a bus 56. The non-volatile memory 52, the PWM timer 53, the AD converter 54, and the rotational angle acquisition circuit 55 are electrically connected to the bus 56 and can communicate with each other. A volatile cache memory 511 is mounted in the CPU 51. Further, a program PR5 is stored in the non-volatile memory 52. The rotational angle acquisition circuit 55 includes an encoder interface (hereinafter, also referred to as encoder IF) 550. The CPU 51 executes various processing related to motor control by reading and executing the program PR5 from the non-volatile memory 52. Note that the PWM timer is a timer circuit designed for PWM control. A PWM counter is included inside the PWM timer circuit. A PWM counter value periodically increases and decreases, and corresponds to a PWM carrier signal.

The CPU 51 transmits a control signal to the PWM timer 53. The PWM timer 53 generates a PWM signal based on the control signal and transmits it to the inverter 60. The inverter 60 is PWM-controlled by the PWM signal and supplies current to the motor 70. The AD converter 54 performs A/D conversion on U-phase, V-phase, and W-phase current values supplied to the motor 70 to detect the current values. An analog signal representing the current value is generated by, for example, a current sensor. The encoder IF 550 receives, from the encoder 80, a signal capable of specifying the angular position of the rotor of the motor 70, and acquires the angular position. The CPU 51 performs a predetermined computation (hereinafter, also referred to as current control computation) using the detected current value and the acquired angular position, generates a control signal based on the computation result, and transmits it to the PWM timer 53.

FIG. 14 is a diagram illustrating a relationship among magnetic flux, current, and torque in a motor. Here, as illustrated in FIG. 14, a case where current I [A] flows in a direction rotated by an angle δ from a direction of the motor rotor, which can be considered as a bar magnet, that is, a direction of the angular position θ representing a direction of magnetic flux Φ is assumed. In this case, the torque T [N·m] generated in the motor rotor is expressed as a product of the magnetic flux Φ [Wb] of the motor rotor and a current component I sin (δ) orthogonal to the direction of the magnetic flux Φ. That is, the equation T=ΦI sin (δ) holds. The CPU performs current control computation using the detected current value and the acquired angular position θ in order to control the rotational speed of the motor rotor as commanded while efficiently generating torque in the motor rotor (minimizing losses as much as possible).

When transmitting signals from the encoder 80 to the encoder IF 550, serial communication is generally used. Accordingly, the time required to acquire the angular position of the motor rotor tends to be relatively long. Therefore, as a general standard method, a method in which acquisition of an angular position used for current control computation in a period n of a PWM carrier signal is started at a timing corresponding to a start of a previous period n−1 may be considered. The timing of the start of period n−1 corresponds to, for example, the point at which a waveform representing a PWM counter value reaches a trough, that is, the point at which the peak value of the PWM carrier signal reaches its minimum value.

FIG. 15 is a diagram illustrating a time chart of each processing in control of one motor by the standard method. In the standard method, for example, as illustrated in FIG. 15, at time Ta corresponding to the start of period n, the CPU 51 causes the AD converter 54 to start the detection of the U-phase, V-phase, and W-phase current values flowing through the motor. Also, at the same time Ta, the CPU 51 causes the encoder IF 550 to start the acquisition of the angular position θ of the motor rotor from the encoder 80. Next, at time Tb when the detection of current value ends, the CPU 51 starts current control computation using the detected current values and the angular position acquired in the previous period. The current control computation ends at time Tc. At time Tc, the acquisition of the angular position is still ongoing. The acquisition of the angular position ends at time Td. Thereafter, at time Te, period n of the PWM carrier signal ends.

Next, a case of controlling multiple motors by one MCU will be considered.

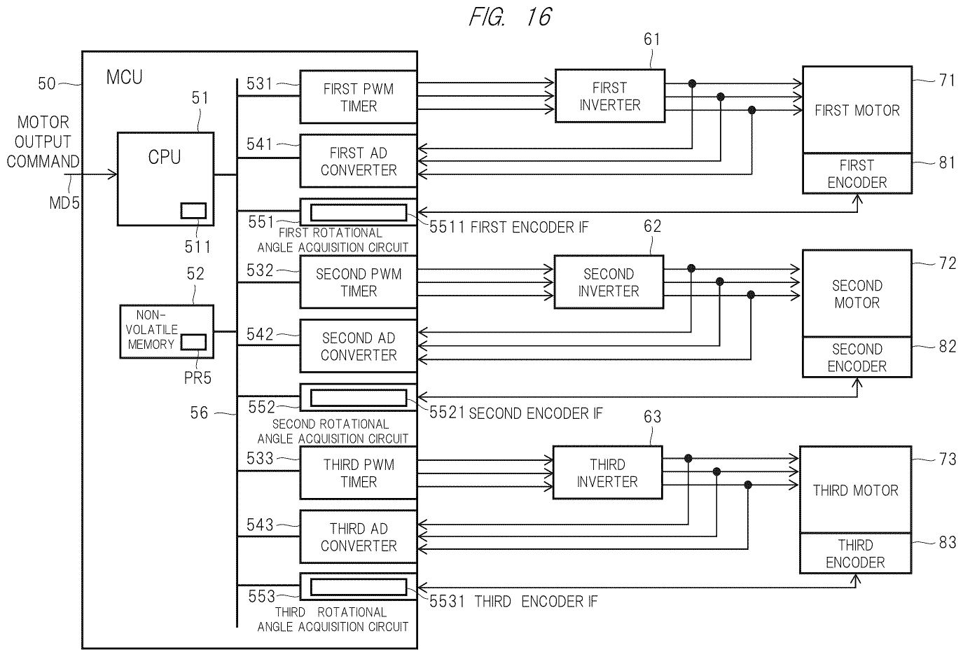

FIG. 16 is a diagram illustrating a configuration example of a motor control system that controls three motors. As illustrated in FIG. 16, when controlling three motors, three sets each including an inverter, a motor, and an encoder are required in addition to the MCU. That is, the motor control system includes first, second, and third inverters 61, 62, and 63, first, second, and third motors 71, 72, and 73, and first, second, and third encoders 81, 82, and 83.

The MCU 50 basically has a configuration similar to that illustrated in FIG. 13, and includes the CPU 51 in which the cache memory 511 is mounted and the non-volatile memory 52 storing the program PR5. However, the MCU 50 has sets of a PWM timer, an AD converter, and a rotational angle acquisition circuit each corresponding to the three motors.

Specifically, the MCU 50 includes a first PWM timer 531, a first AD converter 541, and a first rotational angle acquisition circuit 551, each corresponding to the first motor 71. The first rotational angle acquisition circuit 551 includes a first encoder IF 5511. Also, the MCU 50 includes a second PWM timer 532, a second AD converter 542, and a second rotational angle acquisition circuit 552, each corresponding to the second motor 72. The second rotational angle acquisition circuit 552 includes a second encoder IF 5521. Similarly, the MCU 50 includes a third PWM timer 533, a third AD converter 543, and a third rotational angle acquisition circuit 553, each corresponding to the third motor 73. The third rotational angle acquisition circuit 553 includes a third encoder IF 5531.

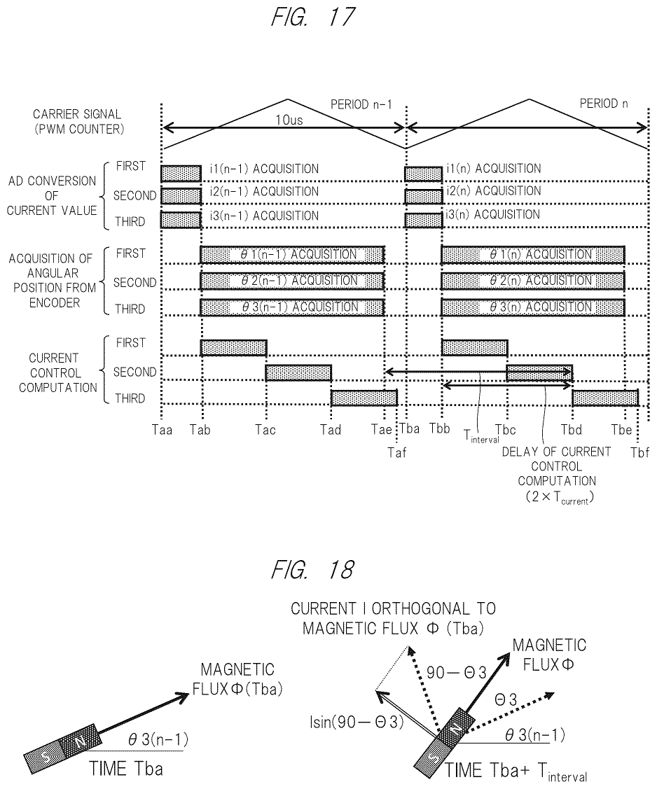

FIG. 17 is a diagram illustrating a time chart of each processing in control of three motors by the standard method. In the standard method, for example, as illustrated in FIG. 17, at time Taa corresponding to the start of period n−1, the CPU 51 causes each AD converter to start the detection of the current value of each motor. Specifically, the CPU 51 causes the first to third AD converters 541, 542, and 543 to start the detection of the current values i1(n−1), i2(n−1), and i3(n−1) flowing through the first to third motors 71, 72, and 73.

At time Tab when the detection of the current value of each motor by each AD converter ends, the CPU 51 causes each encoder IF to start the acquisition of the angular position of each motor rotor from each encoder. Specifically, the CPU 51 causes the first to third encoder IFs 5511, 5521, and 5531 to start the acquisition of the angular positions θ1(n−1), θ2(n−1), and θ3(n−1) of the respective motor rotors.

The CPU 51 cannot start current control computations unless the current values have been acquired. Further, the CPU 51 cannot perform multiple current control computations in parallel. Therefore, the CPU 51 starts current control computation at time Tab when the detection of the current value of each motor ends. First, at time Tab, the CPU 51 starts the current control computation corresponding to the first motor 71. This current control computation ends at time Tac. At time Tac, the CPU 51 starts the current control computation corresponding to the second motor 72. This current control computation ends at time Tad. At time Tad, the CPU 51 starts the current control computation corresponding to the third motor 73. This current control computation ends at time Taf.

Meanwhile, the acquisition of the angular positions θ1(n−1), θ2(n−1), and θ3(n−1) ends at time Tae. Note that the timing of starting the acquisition of the angular position may be at time Taa. Also, the time Tae when the acquisition of the angular position ends may be before or after time Taf.

In the next period n as well, the same processing is executed. At time Tba corresponding to the start of period n, the CPU 51 causes each AD converter to start the detection of the current value of each motor. Specifically, the CPU 51 causes the first to third AD converters 541, 542, and 543 to start the detection of the current values i1(n), i2(n), and i3(n) flowing through the first to third motors 71, 72, and 73.

At time Tbb when the detection of the current value of each motor by each AD converter ends, the CPU 51 causes each encoder IF to start the acquisition of the angular position of each motor rotor from each encoder. Specifically, the CPU 51 causes the first to third encoder IFs 5511, 5521, and 5531 to start the acquisition of the angular positions θ1(n), θ2(n), and θ3(n) of the respective motor rotors.

At time Tbb, the CPU 51 starts the current control computation corresponding to the first motor 71. This current control computation ends at time Tbc. At time Tbc, the CPU 51 starts the current control computation corresponding to the second motor 72. This current control computation ends at time Tbd. At time Tbd, the CPU 51 starts the current control computation corresponding to the third motor 73. This current control computation ends at time Tbf.

Meanwhile, the acquisition of angular positions θ1(n), θ2(n), and θ3(n) ends at time Tbe.

In the time chart illustrated in FIG. 17, the current control computation corresponding to the third motor 73 in period n is started at time Tbd. The timing of the start of period n is time Tba. The current control computations are performed sequentially for respective motors. Here, the time from time Tae when the rotational angle is acquired in period n−1 to time Tbd when the current control computation for the third motor 73 in period n is started is defined as Tᵢₙₜₑᵣᵥₐₗ. At this time, the time Tᵢₙₜₑᵣᵥₐₗ becomes longer as compared with the time from the acquisition of the rotational angle to the start of current control computation in the case of the first motor 71 or the second motor 72. Also, the time required for the current control computation of the first motor 71 is defined as T_{current}. Then, the current control computation for the third motor 73 is started with a delay of 2×T_{current} from time Tbb when the current control computation for the first motor 71 is started.

FIG. 18 is a diagram for describing a shift of current with respect to magnetic flux in a motor. The left diagram in FIG. 18 illustrates the state of the motor rotor of the third motor 73 at time Tba. Also, the right diagram in FIG. 18 illustrates the state of the motor rotor of the third motor 73.

At time Tba, the direction of the magnetic flux Φ(Tba) of the motor rotor in the third motor 73 is the direction of the angular position θ3(n−1). Meanwhile, consider the direction of the magnetic flux Φ of the motor rotor at the timing when the current control computation corresponding to the third motor 73 is started, that is, at time Tbd, which is time Tᵢₙₜₑᵣᵥₐₗ after time Tba. At time Tbd, the direction of the magnetic flux Φ becomes the direction further rotated by Θ3 from the angular position θ3(n−1) during a lapse of time Tᵢₙₜₑᵣᵥₐₗ. In this case, the direction of the current I to be supplied to the third motor 73 determined by the current control computation becomes a direction of 90-Θ3 degrees orthogonal to the magnetic flux Φ(Tba). However, the direction of the actual magnetic flux of the motor rotor is not the past magnetic flux Φ(Tba), but the direction of the magnetic flux Φ. Therefore, the current component orthogonal to the magnetic flux Φ becomes I sin (90-Θ3), and the generated torque T is reduced as compared with assumed ΦI.

From the above, the following can be understood. If the timing of starting the acquisition of the angular position is early, the angular position used for computation becomes relatively old information when performing the current control computation. As a result, the accuracy of current control computation decreases, and the difference between the AC current that should originally be supplied to the motor and the AC current obtained by current control computation becomes large, especially during acceleration and deceleration of the motor rotor. Consequently, the full potential of the motor cannot be sufficiently drawn out, and the torque generated in the motor rotor may decrease. Furthermore, since cost reduction is emphasized for a controller such as an MCU, computations are often performed by a single CPU, and current control computations basically cannot be performed in parallel. Therefore, when there is a plurality of motors to be controlled by the controller, multiple current control computations will be performed sequentially. Then, as an order of the current control computations performed by the CPU becomes later, the accuracy of torque control for the motor corresponding to the current control computation decreases.

Based on the above study results, the present inventor devised the semiconductor device proposed in this application. Hereinafter, embodiments of the semiconductor device proposed in this application will be described.

### Embodiment

### Outline of Embodiment

In this embodiment, in order to solve the above-mentioned problems, the timing of starting the acquisition of the angular position of the motor rotor is set later than the general timing. Specifically, the controller detects the current value supplied from the inverter to the motor and performs current control computation using the detected current value and the angular position acquired most recently. At this time, the controller starts the detection of the angular position to be used in the current control computation of the next period, at a predetermined timing during the current control computation. This makes it possible to optimize the angular position used for current control computation into newer information that is temporally closer to the actual angular position, and increase the torque generated in the motor rotor.

### Configuration of Motor Control System

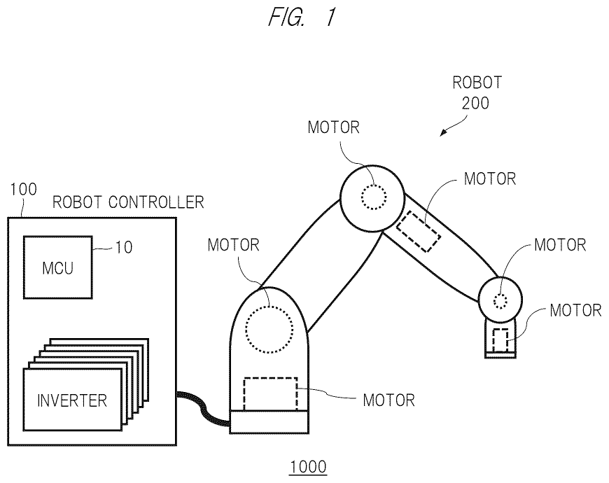

FIG. 1 is a diagram schematically illustrating the configuration of the motor control system according to the embodiment. As illustrated in FIG. 1, a motor control system 1000 according to the embodiment includes a robot controller 100 and a robot 200. The robot controller 100 includes an MCU and a plurality of inverters. The robot 200 is, for example, a vertically articulated robot or an arm-type robot. The robot 200 has a plurality of motors. The plurality of motors is used for a joint mechanism of the arm, a shaft rotation mechanism of the arm, a gripping mechanism at a tip end of the arm, and the like. The MCU controls the plurality of inverters. The plurality of inverters each supplies current to each of the plurality of motors. Note that the MCU is an example of the semiconductor device that functions as a controller. The MCU can be replaced by other types of semiconductor devices that function as controllers.

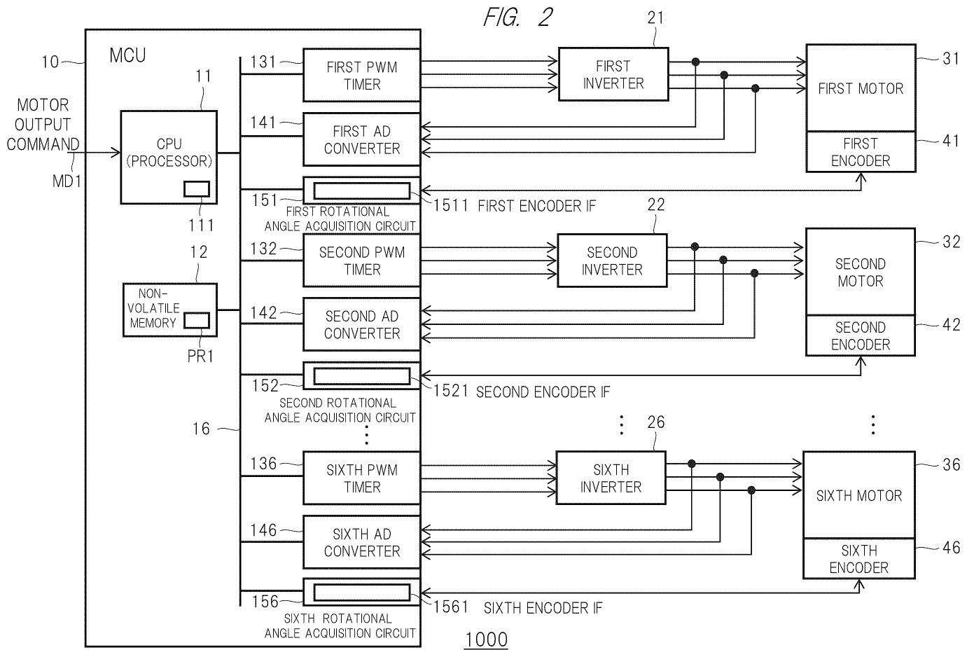

FIG. 2 is a diagram illustrating the configuration of the motor control system according to the embodiment in detail. As illustrated in FIG. 2, the motor control system 1000 includes an MCU 10. Also, the motor control system 1000 has a first inverter 21, a second inverter 22, . . . , and a sixth inverter 26. Further, the motor control system 1000 has a first motor 31, a second motor 32, . . . , and a sixth motor 36. The first inverter 21, the second inverter 22, . . . , and the sixth inverter 26 receive control from the MCU 10 and each supply current to the first motor 31, the second motor 32, . . . , and the sixth motor 36, respectively. Note that the MCU 10 is an example of a “semiconductor device” in this application.

The motor control system 1000 has a first encoder 41, a second encoder 42, . . . , and a sixth encoder 46. The first encoder 41, the second encoder 42, . . . , and the sixth encoder 46 are each electrically connected to the first motor 31, the second motor 32, . . . , and the sixth motor 36, respectively. The first encoder 41 outputs a signal capable of specifying the angular position of the motor rotor of the first motor 31. Similarly, the second encoder 42, . . . , and the sixth encoder 46 each output a signal capable of specifying the angular position of each motor rotor of the second to sixth motors 32 to 36, respectively.

The MCU 10 has a CPU 11 and a non-volatile memory 12. The non-volatile memory 12 may be, for example, a ROM, a PROM (Programmable Read Only Memory), or the like. A predetermined program PR1 is stored in the non-volatile memory 12. Further, the MCU 10 has a first PWM timer 131, a second PWM timer 132, . . . , and a sixth PWM timer 136. The MCU 10 has a first AD converter 141, a second AD converter 142, . . . , and a sixth AD converter 146. The MCU 10 has a first rotational angle acquisition circuit 151, a second rotational angle acquisition circuit 152, . . . , and a sixth rotational angle acquisition circuit 156. The first rotational angle acquisition circuit 151 includes a first encoder IF 1511. Similarly, the second to sixth rotational angle acquisition circuits each correspondingly include a second encoder IF 1521, . . . , and a sixth encoder IF 1561. Furthermore, the MCU 10 has a bus 16. Note that the CPU 11 is an example of a “processor” in this application.

The CPU 11, the non-volatile memory 12, the first to sixth PWM timers 131 to 136, the first to sixth AD converters 141 to 146, and the first to sixth rotational angle acquisition circuits 151 to 156 are electrically connected to the bus 16. Each of these elements constituting the MCU 10 can transmit signals or data bidirectionally via the bus 16. In this example, the non-volatile memory 12 is provided inside the MCU 10 and is electrically connected to the CPU 11. However, the non-volatile memory 12 may be provided outside the MCU 10 and electrically connected to the CPU 11.

The first to sixth inverters 21 to 26 and the first to sixth motors 31 to 36 are of a three-phase AC type. The first PWM timer 131 transmits three-phase PWM signals, that is, a U-phase PWM signal, a V-phase PWM signal, and a W-phase PWM signal, to the first inverter 21. Similarly, the second to sixth PWM timers 132 to 136 each transmit three-phase PWM signals to the second to sixth inverters 22 to 26. Also, the first inverter 21 supplies three-phase currents, that is, a U-phase current, a V-phase current, and a W-phase current, to the first motor 31. Similarly, the second to sixth inverters 22 to 26 each supply three-phase currents to the second to sixth motors 32 to 36.

The first AD converter 141 detects the three-phase current values supplied from the first inverter 21 to the first motor 31. Similarly, the second to sixth AD converters 142 to 146 each detect the three-phase current values supplied from the second to sixth inverters 22 to 26 to respective motors. Also, the first encoder IF 1511 acquires the angular position from the first encoder 41. Similarly, the second to sixth encoder IFs 1521 to 1561 each acquire the angular position from the second to sixth encoders 42 to 46.

The CPU 11 executes various processing related to motor control by reading and executing the program PR1 from the non-volatile memory 12, in other words, by following the program PR1 stored in the non-volatile memory 12. The CPU 11 receives, for example, input of a motor output command MD1. The motor output command MD1 represents the respective outputs of the first to sixth motors 31 to 36, that is, command signals such as torque or rotational speed. The CPU 11 receives the three-phase current values from the first inverter 21 detected by the first AD converter 141 and the angular position of the motor rotor of the first motor 31 from the first encoder IF 1511.

The CPU 11 performs the first current control computation for the first motor 31 based on the input output command for the first motor 31, the three-phase current values from the first inverter 21, and the angular position of the motor rotor of the first motor 31. The first current control computation for the first motor 31 is a computation for obtaining information to control the three-phase AC currents to be supplied from the first inverter 21 to the first motor 31. The CPU 11 generates a first current control signal based on the information obtained from the first current control computation and transmits it to the first PWM timer 131 such that the three-phase AC currents are supplied from the first inverter 21 to the first motor 31.

The information obtained from the first current control computation is, for example, a PWM duty ratio in PWM control. The first current control signal is, for example, a signal representing this PWM duty ratio. In PWM control, determining the PWM duty ratio is equivalent to determining a modulated wave for the first carrier signal. The first PWM timer 131 adjusts the first carrier signal and the modulated wave to generate three-phase PWM signals based on this first current control signal, and outputs them to the first inverter 21. The CPU 11 also executes similar processing for the second to sixth motors 32 to 36.

### Current Control Processing for One Motor

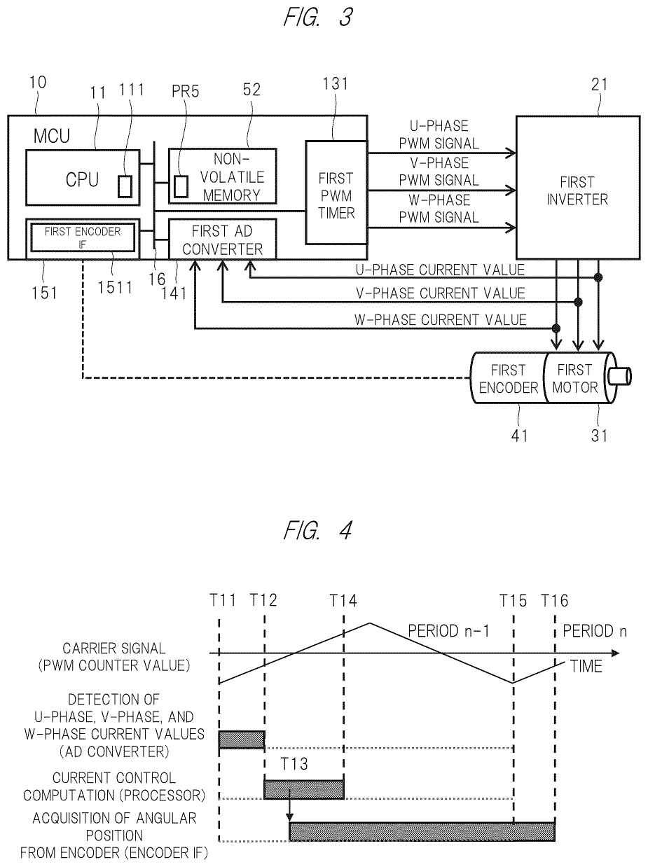

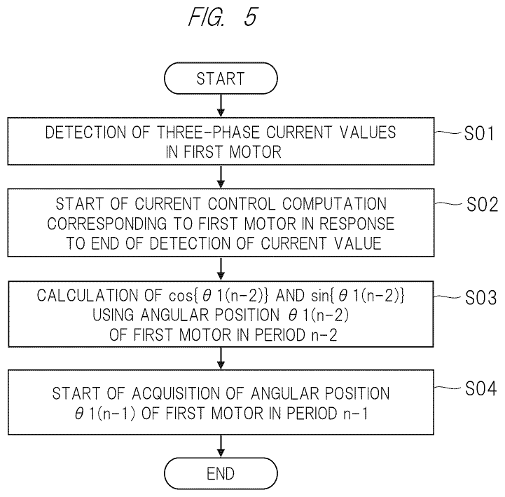

FIG. 3 is a configuration diagram of a current control system corresponding to one motor. The current control system illustrated in FIG. 3 represents only the system for controlling the first motor 31 in the motor control system 1000 illustrated in FIG. 2. FIG. 4 is a time chart of current control processing corresponding to one motor.

FIG. 5 is a flowchart of the processing related to control of one motor in the MCU. The processing related to control of the first motor 31 in the MCU 10 is configured by, for example, the processing including respective steps illustrated in FIG. 5. Here, for simplicity of description, the flow of processing for approximately one period of the carrier signal for one motor will be described. This processing includes processing related to current control computation.

In step S01, the detection of three-phase current values in the first motor 31 is performed. Specifically, the CPU 11 executes processing to cause the first AD converter 141 to start the detection of the first current values of the U-phase, V-phase, and W-phase in the first motor 31. The detection of the first current value ends after a certain period of time has elapsed since the start of the detection. In the time chart illustrated in FIG. 4, the detection of the first current value is started at time T11 and ends at time T12.

In step S02, in response to the end of the detection of the first current value, the first current control computation corresponding to the first motor 31 is started. Specifically, when the detection of the first current value in step S01 ends, the CPU 11 executes processing to start the first current control computation corresponding to the first motor 31. In the time chart illustrated in FIG. 4, the first current control computation is started at time T12 and ends at time T14.

In step S03, in response to the execution of the first current control computation, the acquisition of the first angular position is started. Specifically, the CPU 11 executes processing to cause the first encoder IF 1511 to start the acquisition of the first angular position, using any timing in the first current control computation as a trigger.

In this example, in the first current control computation, the calculation of cos {θ1(n−2)} and sin {θ1(n−2)} is performed using the first angular position θ1(n−2) of the first motor 31 in period n−2. Specifically, the CPU 11 performs computation processing for cos {θ1(n−2)} and sin {θ1(n−2)} using the first angular position θ1(n−2) as a part of the aforementioned first current control computation. This partial computation corresponds to, for example, the final computation that requires the use of the first angular position θ1(n−2). Once this partial computation ends, the first angular position θ1(n−2) becomes unnecessary. After this partial computation ends, the CPU 11 causes the first encoder IF 1511 to start the acquisition of a new first angular position θ1(n−1).

In this way, the previous old first angular position θ1(n−2) can be overwritten, thereby saving memory capacity. In the time chart illustrated in FIG. 4, the partial computation is performed between time T12 and time T13.

In step S04, the acquisition of the first angular position θ1(n−1) of the first motor 31 in period n−1 is started. Specifically, the first encoder IF 1511 in the first rotational angle acquisition circuit 151 executes processing to cause the first encoder 41 to start the transmission of the first angular position θ1(n−1). The acquisition of the first angular position θ1(n−1) is started at time T13 which is between time T12 and time T14, and ends, for example, at time T16 which is after the start time T15 of the next period n.

As a computation result of the first current control computation, for example, the CPU 11 obtains the PWM duty ratio for PWM control in the first PWM timer 131. The CPU 11 transmits a first current control signal representing the obtained PWM duty ratio to the first PWM timer 131. The first PWM timer 131 sets and updates the PWM duty ratio based on the received first current control signal. This determines the modulated wave for the first PWM carrier signal represented by the PWM counter value inside the first PWM timer 131. The first PWM timer 131 generates a first PWM signal based on the first PWM carrier signal and the PWM duty ratio (modulated wave), and transmits it to the first inverter 21.

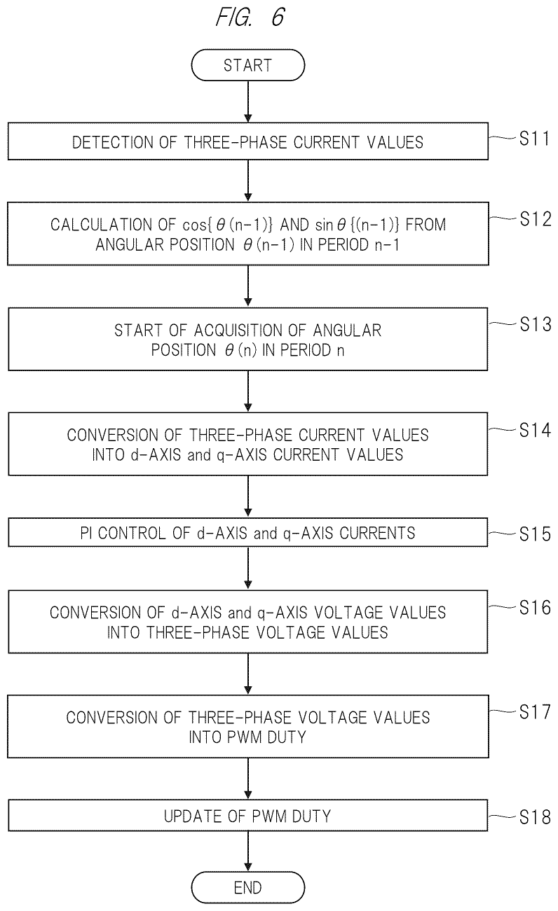

FIG. 6 is a flowchart of current control processing corresponding to one motor. The current control processing is configured by, for example, the processing including respective steps illustrated in FIG. 6. Here, for simplicity of description, the flow of current control processing for one period of the carrier signal for one motor will be described.

In step S11, processing to detect the three-phase current values is performed. Specifically, the CPU 11 executes processing to cause the first AD converter 141 to start the AD conversion (detection) of the three-phase currents flowing through the first motor 31 at the timing when the PWM counter value of the first PWM timer 131 reaches a trough. Note that the aforementioned three-phase currents are the U-phase current, V-phase current, and W-phase current supplied from the first inverter 21 to the first motor 31. Also, the PWM counter value corresponds to the PWM carrier signal, and the timing when the PWM counter value reaches a trough corresponds to the timing when the signal value of the PWM carrier signal reaches its minimum value. This timing is the timing of the start of the period of the PWM carrier signal. When the AD conversion by the first AD converter 141 is completed, the CPU 11 executes processing to acquire the three-phase current values flowing through the first motor 31 in period n−1 from the first AD converter 141.

When the AD conversion in step S11 is completed, the processing step moves to step S12, and the CPU 11 starts the current control computation. In the current control computation, the three-phase current value i(n−1) in period n−1 and the angular position θ(n−2) in the previous period n−2 are used.

In step S12, processing to calculate cos {θ(n−2)} and sin {θ(n−2)} from the angular position θ in period n−2 is performed. Specifically, the CPU 11 executes processing to calculate cos {θ(n−2)} and sin {θ(n−2)} based on the angular position θ(n−2) whose acquisition is started and completed in period n−2 in the PWM carrier signal.

In step S13, processing to start the acquisition of the angular position θ(n−1) in period n is performed. Specifically, when cos {θ(n−2)} and sin {θ(n−2)} are calculated in step S12, the CPU 11 executes processing to generate a software interrupt. Also, the CPU 11 executes processing to cause the first encoder IF 1511 to start the transmission of the angular position θ(n−1), which is used for current control computation in period n of the PWM carrier signal, from the first encoder 41. That is, the CPU 11 executes processing to activate the first encoder IF 1511. The first encoder IF 1511 transmits, to the first encoder 41, a command requesting the angular position θ(n−1).

The first encoder IF 1511 starts the transmission of a signal capable of specifying the angular position θ(n−1) from the first encoder 41. The first encoder IF 1511 continues to transmit the signal capable of specifying the angular position θ(n−1) even after the next step S14.

In step S14, processing to convert the three-phase current values into d-axis and q-axis current values is performed. Specifically, the CPU 11 executes processing to convert the U-phase current value, V-phase current value, and W-phase current value acquired in step S11 into d-axis current value and q-axis current value.

In step S15, processing to perform PI control of the d-axis and q-axis currents is performed. Specifically, the CPU 11 executes processing to perform the PI control of the d-axis current and q-axis current.

In step S16, processing to convert d-axis and q-axis voltage values into three-phase voltage values is performed. Specifically, the CPU 11 executes processing to convert the d-axis voltage value and q-axis voltage value into U-phase voltage value, V-phase voltage value, and W-phase voltage value.

In step S17, processing to convert the three-phase voltage values into PWM duty ratio is performed. Specifically, the CPU 11 executes processing to convert the U-phase voltage value, V-phase voltage value, and W-phase voltage value into PWM duty ratio for PWM control of the inverter. When the processing in step S17 ends, the current control computation is completed.

In step S18, processing to update the PWM duty ratio is performed. Specifically, when the current control computation ends, the CPU 11 executes processing to set and update the PWM duty ratio converted in step S17 in the first PWM timer 131. The first PWM timer 131 outputs a PWM signal with the updated PWM duty ratio to the first inverter 21. The first inverter 21 outputs voltage to the U-phase, V-phase, and W-phase input wirings of the first motor 31, and supplies current to respective phases of the first motor 31.

According to the current control processing for one motor described above, in response to the execution of the current control computation, for example, the acquisition of the angular position of the motor rotor is started using any timing in the current control computation as a trigger. That is, as compared with the standard method, the timing when the acquisition of the angular position is started is shifted backward in time. Therefore, the angular position used when performing current control computation becomes information at a time temporally closer to the timing of the computation, and errors based on time difference in the angular position can be reduced. In other words, a decrease in the accuracy of current control computation can be suppressed.

### Current Control Processing for Two Motors

The flow of the current control processing for two motors will be described with reference to the drawings. Here, as the current control system, a current control system composed of elements related to the control of the first and second motors 31 and 32 in the motor control system illustrated in FIG. 2 is assumed.

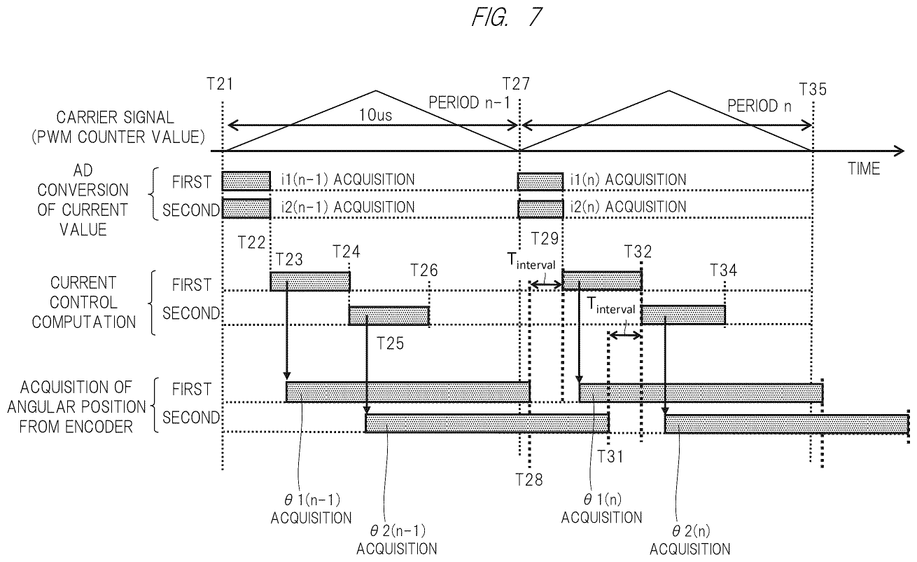

FIG. 7 is a time chart of the current control processing corresponding to two motors. FIG. 7 illustrates a time chart of the current control processing for two motors for approximately two periods of the carrier signal (PWM counter value). Note that one period of the carrier signal is assumed to be, for example, about 10 μs.

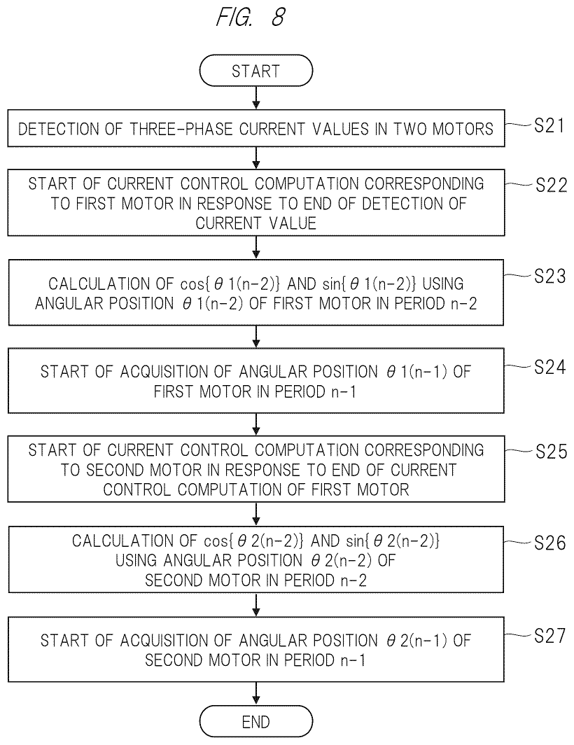

FIG. 8 is a flowchart of the processing related to the control of two motors in the MCU. FIG. 8 illustrates the flow of the current control processing for one period of period n−1 of the carrier signal. In practice, this one-period current control processing is repeated for each number of periods of the carrier signal.

In step S21, processing to detect the three-phase current values in the two motors is performed. Specifically, the CPU 11 executes processing to detect the three-phase current values in each of the first and second motors 31 and 32. Here, the CPU 11 executes processing to cause the first AD converter 141 and the second AD converter 142 to start the AD conversion (detection) of the three-phase current values of each motor at the timing of the start of period n−1. The AD conversions of the three-phase current values of the two motors of the first and second motors 31 and 32, that is, first and second current values, are performed in parallel. When these AD conversions end, the detection of the three-phase first current value i1(n−1) in the first motor 31 and the three-phase second current value i2(n−1) in the second motor 32 ends. In the time chart illustrated in FIG. 7, the detection of the first current value of the first motor and the second current value of the second motor is started at time T21 and ends at time T22.

In step S22, in response to the end of current value detection in the two motors, processing to start the first current control computation corresponding to the first motor 31 is performed. Specifically, when the detection of the first and second current values in the first and second motors 31 and 32 ends, the CPU 11 executes processing to start the first current control computation corresponding to the first motor 31. For the first current control computation, the first angular position θ1(n−2) of the first motor 31 whose acquisition is started and completed in the previous period n−2 and the first current value i1(n−1) of the first motor 31 acquired in period n−1 are used.

When the first current control computation corresponding to the first motor 31 ends, the CPU 11 obtains the PWM duty ratio. The CPU 11 transmits the first current control signal representing the obtained PWM duty ratio to the first PWM timer 131. The first PWM timer 131 sets and updates the PWM duty ratio based on the received first current control signal. The first PWM timer 131 generates the first PWM signal based on the updated PWM duty ratio and outputs it to the first inverter 21. In the time chart illustrated in FIG. 7, the first current control computation corresponding to the first motor is started at time T22 and ends at time T24.

In step S23, in the first current control computation corresponding to the first motor, partial computation using the first angular position of the first motor acquired most recently is performed. Specific details are as follows. The CPU 11 executes processing to perform partial computation using the first angular position θ1(n−2) of the first motor 31 in period n−2 at a predetermined timing during the first current control computation corresponding to the first motor 31. The computation using the first angular position θ1(n−2) is, for example, a computation for calculating cos θ1(n−2) and sin θ1(n−2). In the time chart illustrated in FIG. 7, this computation is started at a time between time T22 and time T23 and ends at time T23.

In step S24, in response to the end of the computation using the angular position of the first motor, the acquisition of the angular position of the first motor in period n−1 is started. Specifically, in response to the end of the computation using the first angular position θ1(n−2), the CPU 11 executes the following processing. The CPU 11 executes processing to cause the first encoder IF 1511 to start the acquisition of the first angular position θ1(n−1) of the first motor 31 in period n−1. In the time chart illustrated in FIG. 7, the acquisition of the first angular position θ1(n−1) is started at time T23 and ends, for example, at time T28 which is after the start time T27 of the next period n.

Note that the acquisition of the first angular position θ1(n−1) from the first encoder 41 ends before the first current control computation corresponding to the first motor 31 in the next period n of the carrier signal is started. That is, after the acquisition of the first angular position θ1(n−1) of the first motor 31 in period n−1 ends, the current control computation corresponding to the first motor 31 in period n is started after a time interval Tᵢₙₜₑᵣᵥₐₗ. In the time chart illustrated in FIG. 7, the first current control computation corresponding to the first motor in period n is started at time T29 when the detection of current value in period n ends, and ends at time T32.

In step S25, in response to the end of the current control computation corresponding to the first motor, the current control computation corresponding to the second motor is started. Specifically, when the first current control computation corresponding to the first motor 31 ends, the CPU 11 executes processing to start the second current control computation corresponding to the second motor 32. When the second current control computation corresponding to the second motor 32 ends, the CPU 11 transmits the second current control signal representing the obtained PWM duty ratio to the second PWM timer 132. The second PWM timer 132 sets and updates the PWM duty ratio based on the received second current control signal. The second PWM timer 132 generates a second PWM signal based on the updated PWM duty ratio and outputs it to the second inverter 22. In the time chart illustrated in FIG. 7, the current control computation corresponding to the second motor is started at time T24.

In step S26, in the current control computation corresponding to the second motor, a computation using the angular position of the second motor acquired most recently is performed. Specific details are as follows. The CPU 11 executes processing to perform a computation using the second angular position θ2(n−2) of the second motor 32 in period n−2 at a predetermined timing during the second current control computation corresponding to the second motor 32. The computation using the angular position θ2(n−2) is, for example, a computation for calculating cos {θ2(n−2)} and sin {θ2(n−2)}.

In step S27, in response to the end of the computation using the angular position of the second motor, the acquisition of the angular position of the second motor in period n−1 is started. Specifically, in response to the end of the computation using the second angular position θ2(n−2), the CPU 11 executes the following processing. The CPU 11 executes processing to cause the second encoder IF 1521 to start the acquisition of the second angular position θ2(n−1) of the second motor 32 in period n−1. In the time chart illustrated in FIG. 7, the acquisition of the second angular position of the second motor in period n−1 is started at time T25 which is between time T24 and time T26.

Note that the acquisition of the second angular position θ2(n−1) from the second encoder 42 ends before the second current control computation corresponding to the second motor 32 in the next period n of the carrier signal is started. That is, after the acquisition of the second angular position θ2(n−1) of the second motor 32 in period n−1 ends, the second current control computation corresponding to the second motor 32 in period n is started after a time interval Tᵢₙₜₑᵣᵥₐₗ. In the time chart illustrated in FIG. 7, the acquisition of the second angular position of the second motor in period n−1 is started at time T25, extends beyond the start time T27 of the next period n, and ends at time T31. Furthermore, the second current control computation for the second motor in period n is started at time T32, which is time Tᵢₙₜₑᵣᵥₐₗ after time T31, and ends at time T34.

Note that the processing related to the control of the first and second motors in period n is similar to the processing in period n−1 as can be understood from the time chart illustrated in FIG. 7. That is, timings of start and end in the detection of the first and second current values i1(n) and i2(n), the first and second current control computations, and the acquisition of the first and second angular positions θ1(n) and θ2(n) are the same as those in period n−1.

In the current control processing for two motors, according to the standard method, the acquisition of the angular positions of the two motors is performed in parallel at the start of the period or at the timing of the end of AD conversion of the current value. Regarding current control computation, the computation for the second motor is started after the computation for the first motor ends. Therefore, in the standard method, the time from the end of the acquisition of the angular position until the start of current control computation using the acquired angular position becomes longer for the second motor. This means that the error in the angular position used in current control computation for the second motor is larger than the error for the first motor, and the accuracy of current control also decreases further.

On the other hand, according to the proposed method, the acquisition of the angular position of the motor rotor is started in response to the execution of current control computation, for example, by using any timing in the current control computation as a trigger. In the proposed method, as compared with the standard method, the timing when the acquisition of the angular position is started is shifted backward in time. Furthermore, the time from the end of the acquisition of the angular position until the start of current control computation using the acquired angular position becomes constant for both the first and second motors. Therefore, the angular position used when performing current control computation becomes information at a time temporally closer to the timing of performing the computation, without depending on the order of the motors for which the current control computation is performed. Error in the angular positions based on the time difference can be similarly reduced for both the first and second motors, and the decrease in accuracy of current control computation can be suppressed to the same level.

### Current Control Processing for Three or More Motors

The flow of current control processing for N motors, where N is three or more, will be described with reference to the drawings. Here, a current control system composed of elements related to the control of the first to sixth motors 31 to 36 in the motor control system illustrated in FIG. 2 is assumed as the current control system.

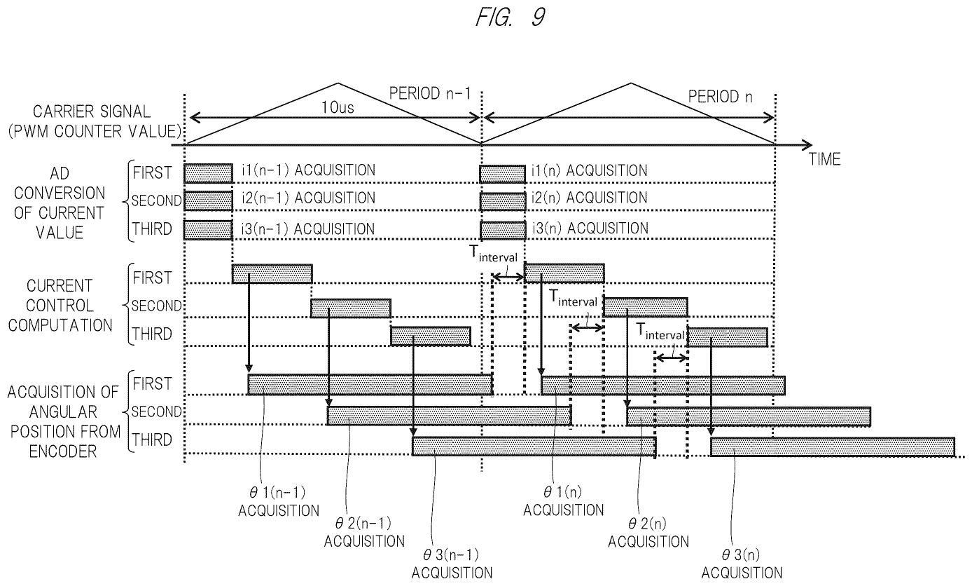

FIG. 9 is a diagram illustrating a time chart of current control processing corresponding to three or more motors. FIG. 9 illustrates a time chart of current control processing for three motors for two periods of the carrier signal (PWM counter value), as an example where multiple motors are controlled. For example, about 10 μs is assumed as one period of the carrier signal.

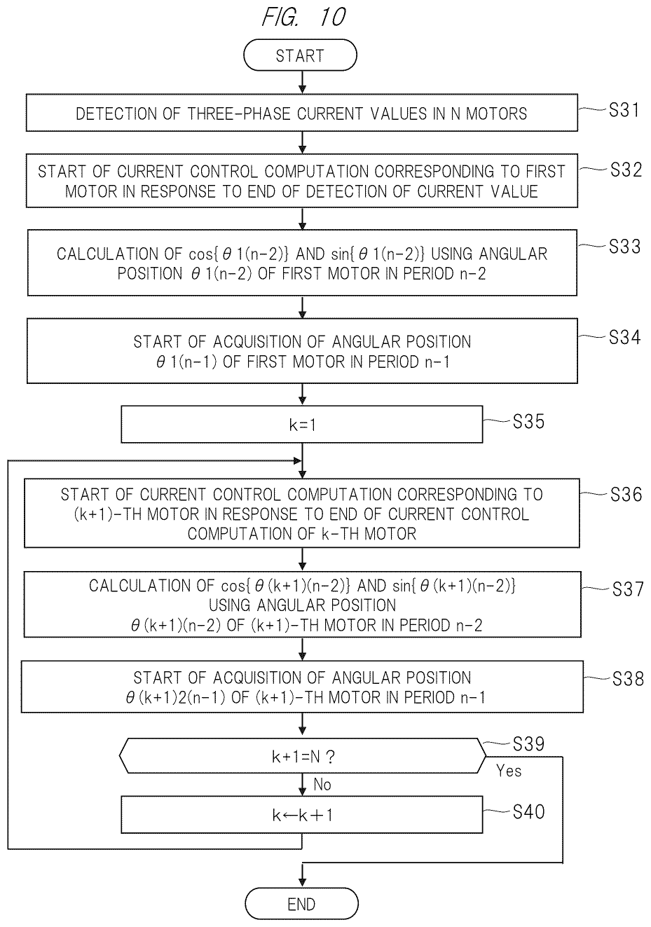

FIG. 10 is a flowchart related to the control of three or more motors in the MCU. FIG. 10 illustrates the flow of current control processing for one period of period n−1 of carrier signal. In practice, this one-period current control processing is repeated for each number of periods of the carrier signal.

In step S31, the three-phase current values of N motors are detected. In this example, the case of controlling six motors (N=6) is assumed. In this step, specifically, the CPU 11 executes processing to detect the three-phase current values in each of the N (six in this example) motors. Here, the CPU 11 executes processing to cause each AD converter corresponding to the first to sixth motors 31 to 36 to start AD conversion (detection) of the three-phase current values in the corresponding motors at the timing of the start of period n−1. When the AD conversion of the three-phase current values in the N motors ends, the detection of the three-phase current values i1(n−1), i2(n−1), . . . , iN(n1) in the first to N-th motors ends.

In step S32, in response to the end of detection of current values in the N motors, processing to start current control computation corresponding to the first motor is performed. Specifically, when the detection of current values in the first to N-th motors ends, the CPU 11 executes processing to start current control computation corresponding to the first motor 31. For the current control computation corresponding to the first motor 31, the angular position θ1(n−2) of the first motor 31 acquired in the previous period n−2 and the current value i1(n−1) of the first motor 31 acquired in period n−1 are used. When the current control computation corresponding to the first motor 31 ends, the CPU 11 sets and updates the obtained PWM duty ratio in the first PWM timer 131. The first PWM timer 131 generates a PWM signal based on the updated PWM duty ratio and outputs it to the first inverter 21.

In step S33, in the current control computation corresponding to the first motor, a computation using the angular position of the first motor acquired most recently is performed. Specifically, the CPU 11 executes processing to perform a computation using the angular position θ1(n−2) of the first motor 31 in period n−2 at a predetermined timing during the current control computation corresponding to the first motor 31. The computation using the angular position θ1(n−2) is, for example, a computation for calculating cos θ1(n−2) and sin θ1(n−2).

In step S34, in response to the end of the computation using the angular position of the first motor in period n−2, the acquisition of the angular position of the first motor in period n−1 is started. Specifically, in response to the end of the computation using the angular position θ1(n−2), the CPU 11 executes processing to cause the first encoder IF 1511 to start the acquisition of the angular position θ1(n−1) in period n−1.

Note that the acquisition of the angular position θ1(n−1) from the first encoder 41 ends before the current control computation corresponding to the first motor 31 in the next period n of the carrier signal is started. That is, after the acquisition of the angular position θ1(n−1) of the first motor 31 in period n−1 ends, the current control computation corresponding to the first motor 31 in period n is started after a time interval Tᵢₙₜₑᵣᵥₐₗ.

The timing of starting the acquisition of the angular position during the current control computation does not change in principle. Furthermore, it is assumed that the time required for current value detection, the time required for current control computation, and the time required for acquisition of angular position are each a certain constant time. In this case, the time Tᵢₙₜₑᵣᵥₐₗ becomes a common constant value in the current control processing of each motor.

In step S35, k=1 is set. Specifically, the CPU 11 executes processing to set 1 to k.

In step S36, in response to the end of the current control computation corresponding to the k-th motor, processing to start the current control computation corresponding to the (k+1)-th motor is performed. Specifically, when the current control computation corresponding to the k-th motor ends, the CPU 11 executes processing to start the current control computation corresponding to the (k+1)-th motor. When the current control computation corresponding to the (k+1)-th motor ends, the CPU 11 executes processing to set and update the obtained PWM duty ratio in the (k+1)-th PWM timer. The (k+1)-th PWM timer generates a PWM signal based on the updated PWM duty ratio and outputs it to the (k+1)-th inverter.

In step S37, a computation using the angular position of the (k+1)-th motor in period n−2 is performed. This computation is a computation for calculating cos {θ(k+1)(n−2)} and sin {θ(k+1)(n−2)} using the angular position θ(k+1)(n−2). Specifically, in the current control computation, the CPU 11 executes computation processing for calculating cos {θ(k+1)(n−2)} and sin {θ(k+1)(n−2)} using the angular position θ(k+1)(n−2).

In step S38, in response to the end of the computation using the angular position of the (k+1)-th motor in period n−2, the acquisition of the angular position of the (k+1)-th motor in period n−1 is started. Specifically, in response to the end of the computation using the angular position θ(k+1)(n−2), the CPU 11 executes processing to cause the (k+1)-th encoder IF to start the acquisition of the angular position θ(k+1)(n−1) in period n−1.

Note that the acquisition of the angular position θ(k+1)(n−1) from the (k+1)-th encoder ends before the current control computation corresponding to the (k+1)-th motor in the next period n of the carrier signal is started. That is, after the acquisition of the angular position θ(k+1)(n−1) of the (k+1)-th motor in period n−1 ends, the current control computation corresponding to the (k+1)-th motor in period n is started after a time interval Tᵢₙₜₑᵣᵥₐₗ.

In step S39, processing to determine whether k+1=N or not is performed. Specifically, the CPU 11 executes processing to determine whether k+1=N or not. If it is determined that k+1=N in this determination (S39: Yes), the current control processing ends. On the other hand, if it is determined that k+1 is not equal to N, that is, k+1<N (S39: No), the processing step proceeds to step S40.

In step S40, processing to increment the value of k by 1 is performed. Specifically, the CPU 11 executes processing to increment the value of k by 1, that is, processing to increase k to k+1 (k←k+1). When the increment processing for k ends, the processing step proceeds to step S36.

When the current control processing corresponding to the N motors in period n−1 ends, the current control processing corresponding to the N motors is repeatedly performed in the next period n. The current control processing in period n is similar to the processing from step S31 to step S40.

As a result, first, in period n−1, current values i1(n−1), i2(n−1), i3(n−1), . . . , iN(n−1) are acquired. Next, the current control computation corresponding to the first motor is started. During this computation, cos θ1(n−2) and sin θ1(n−2) are calculated based on the angular position θ1(n−2) of the first motor whose acquisition is started and completed in the previous period n−2. Then, in response to this calculation, the acquisition of the angular position θ1(n−1) of the first motor is started from the first encoder.

Next, in period n−1, when the current control computation corresponding to the first motor ends, the current control computation corresponding to the second motor is started. During this computation, cos θ2(n−2) and sin θ2(n−2) are calculated based on the angular position θ2(n−2) of the second motor whose acquisition is started and completed in the previous period n−2. Then, in response to this calculation, the acquisition of the angular position θ2(n−1) of the second motor is started from the second encoder.

Subsequently, in period n−1, when the current control computation corresponding to the second motor ends, the current control computation corresponding to the third motor is started. During this computation, cos θ3(n−2) and sin θ3(n−2) are calculated based on the angular position θ3(n−2) of the third motor whose acquisition is started and completed in the previous period n−2. Then, in response to this calculation, the acquisition of the angular position θ3(n−1) of the third motor is started from the third encoder.

In period n−1, the processing related to the current control computation described above is repeated for the number of motors, that is, N times. Thereafter, in period n, the same processing is performed.

In period n, current values i1(n), i2(n), i3(n), . . . , iN(n) are acquired. Next, the current control computation corresponding to the first motor is started. During this computation, cos θ1(n−1) and sin θ1(n−1) are calculated based on the angular position θ1(n−1) of the first motor whose acquisition is started and completed in the previous period n−1. Then, in response to this calculation, the acquisition of the angular position θ1(n) of the first motor is started from the first encoder.

Next, in period n, when the current control computation corresponding to the first motor ends, the current control computation corresponding to the second motor is started. During this computation, cos θ2(n−1) and sin θ2(n−1) are calculated based on the angular position θ2(n−1) of the second motor whose acquisition is started and completed in the previous period n−1. Then, in response to this calculation, the acquisition of the angular position θ2(n) of the second motor is started from the second encoder.

Subsequently, in period n, when the current control computation corresponding to the second motor ends, the current control computation corresponding to the third motor is started. During this computation, cos θ3(n−1) and sin θ3(n−1) are calculated based on the angular position θ3(n−1) of the third motor whose acquisition is started and completed in the previous period n−1. Then, in response to this calculation, the acquisition of the angular position θ3(n) of the third motor is started from the third encoder.

In period n, the processing related to the current control computation described above is repeated for the number of motors to be controlled, that is, N times. Thereafter, in period n+1, the same processing is performed.

In this way, for each period of the PWM carrier signal, the same current control processing is repeatedly performed for each motor or inverter.

The above can be summarized as follows. In the current control computation, when the computation using the angular position θ(n−2) whose acquisition is started and completed in the previous period n−1 ends, the MCU 10 performs a software interrupt and starts communication with the encoder. The communication time between the MCU 10 and the encoder is shorter than the time for one period of the PWM carrier signal. Therefore, the angular position θ(n−1) in period n−1 can be acquired before the current control computation in period n of the PWM carrier signal is started. Furthermore, by starting the communication with the encoder by using the execution of the current control computation as a trigger, the time Tᵢₙₜₑᵣᵥₐₗ from the acquisition of the angular position to the start of the current control computation can be kept constant even if the number of motors increases. That is, the current control computation is performed using the angular position acquired at constant time interval or phase interval. Therefore, not only high accuracy but also high stability can be achieved in current control for motor.

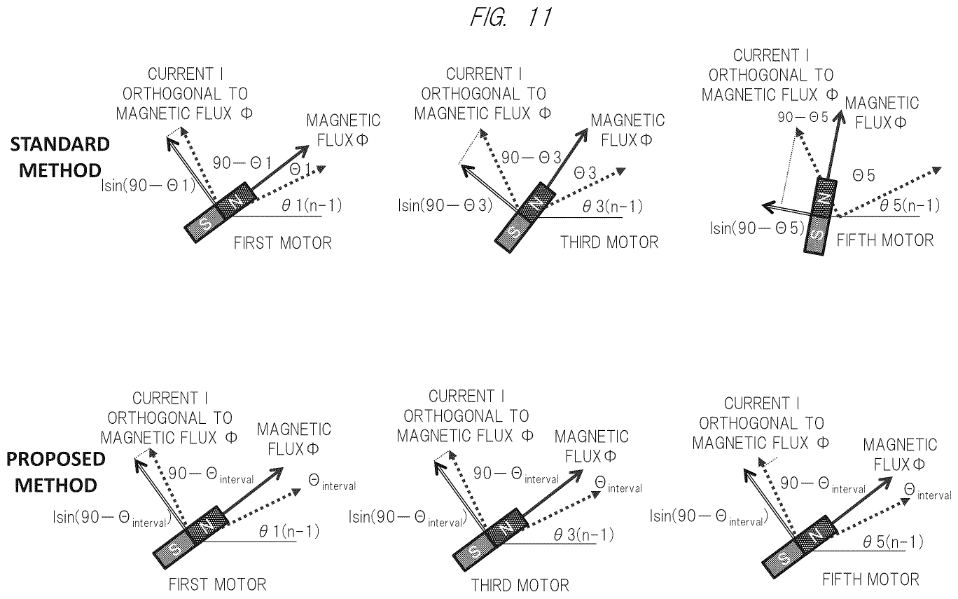

FIG. 11 is a diagram illustrating results of comparison between the standard method and the proposed method with respect to the relationship between magnetic flux and current in motors. The standard method is a method based on general ideas. In the standard method, the timing of starting the acquisition of the angular position from the encoder is the same as the start timing of the PWM carrier signal, that is, the timing of starting the detection of the current value. The timing of starting the acquisition of the angular position is the same for all the motors. On the other hand, the proposed method is a method proposed in this embodiment. In the proposed method, the timing of starting the acquisition of the angular position from the encoder is a predetermined timing during the current control computation performed after the detection of current value. The current control computation is performed sequentially for each motor. Therefore, the timing of starting the acquisition of the angular position differs for each motor, and as described above, the time Tᵢₙₜₑᵣᵥₐₗ from the completion of the acquisition of angular position to the start of current control computation is constant.

The upper part of FIG. 11 illustrates the relationship between the direction of magnetic flux φ and the direction of current I for the first, third, and fifth motors in the same period n, in the case where current control processing based on the standard method is performed. Also, the lower part of FIG. 11 illustrates the relationship between the direction of magnetic flux φ and the direction of current I for the first, third, and fifth motors in the same period n, in the case where current control processing based on the proposed method is performed. Here, the motor rotor is regarded as a bar magnet with an N pole on one end and an S pole on the other end. Furthermore, in FIG. 11, the motor rotor is assumed to rotate counterclockwise (leftward). Also, for convenience, the direction of the angular position of the motor rotor and the direction of the magnetic flux φ of the motor rotor are assumed to be the same.

First, referring to the upper part of FIG. 11, the case of the standard method will be considered. First, the first motor will be focused on. The direction of the actual magnetic flux Φ of the motor rotor (solid arrow) at the time of performing the current control computation corresponding to the first motor is shifted by an angle Θ1 relative to the direction of the acquired angular position θ1(n−1) of the motor rotor (dashed arrow). The shift by angle Θ1 is caused by the rotation of motor rotor during the elapsed time including the time required for the acquisition of the angular position and the time from the acquisition of the angular position to the start of the current control computation. The timing when the acquisition of the angular position is started is fixed to the timing of the start of the period of the PWM carrier signal. Therefore, as compared with the proposed method described later, the time from the acquisition of the angular position to the start of the current control computation becomes longer.

When current I flows in the direction (solid arrow) orthogonal to the direction of the actual magnetic flux Φ of the motor rotor, the motor rotor rotates with proper torque without loss. However, in the current control computation corresponding to the first motor, the acquired angular position θ1(n−1) is used instead of the angular position representing the direction of the actual motor rotor (direction of magnetic flux Φ). In this current control computation, the PWM duty ratio is calculated such that current I flows in a direction orthogonal to the direction of the angular position θ1(n−1), that is, in a direction rotated by 90-Θ1 degrees from the direction of magnetic flux Φ. Therefore, the current component flowing in the direction orthogonal to the direction of the actual magnetic flux Φ becomes current I sin (90-Θ1). That is, a loss equivalent to the shift by angle Θ1 occurs in the torque of the motor rotor.

Next, the third motor will be focused on. The direction of the actual magnetic flux Φ of the motor rotor (solid arrow) at the time of performing the current control computation corresponding to the third motor is shifted by an angle Θ3 relative to the direction of the acquired angular position θ3(n−1) of the motor rotor (dashed arrow). The shift by angle Θ3 is caused by the rotation of motor rotor during the elapsed time including the time required for acquiring the angular position and the time from the acquisition of the angular position to the start of the current control computation. The timing when the acquisition of the angular position is started is fixed to the timing of the start of the period of the PWM carrier signal. The current control computation is performed sequentially for each motor. Therefore, the timing when the current control computation corresponding to the third motor is started is later than the timing when the current control computation corresponding to the first motor is started. Thus, angle Θ3 is basically larger than angle Θ1.

In the current control computation corresponding to the third motor, the PWM duty ratio is calculated such that current I flows in a direction orthogonal to the direction of the acquired angular position θ3(n−1), that is, in a direction rotated by 90-Θ3 degrees from the direction of magnetic flux Φ. Therefore, the current component flowing in a direction orthogonal to the direction of the actual magnetic flux Φ becomes current I sin (90-Θ3). That is, a loss equivalent to the shift by angle Θ3, which is larger than angle Θ1, occurs in the torque of the motor rotor.

Next, the fifth motor will be focused on. The direction of the actual magnetic flux Φ of the motor rotor (solid arrow) at the time of performing the current control computation corresponding to the fifth motor is shifted by an angle Θ5 relative to the direction of the acquired angular position θ5(n−1) of the motor rotor (dashed arrow). The shift by angle Θ5 is caused by the rotation of motor rotor during the elapsed time including the time required for acquiring the angular position and the time from the acquisition of the angular position to the start of the current control computation. The current control computation is performed sequentially for each motor. Therefore, the timing when the current control computation corresponding to the fifth motor is started is later than the timing when the current control computation corresponding to the third motor is started. Therefore, angle Θ5 is basically larger than angle Θ3.

In the current control computation corresponding to the fifth motor, the PWM duty ratio is calculated such that current I flows in a direction orthogonal to the direction of the acquired angular position θ5(n−1), that is, in a direction rotated by 90-Θ5 degrees from the direction of magnetic flux Φ. Therefore, the current component flowing in the direction orthogonal to the direction of actual magnetic flux Φ becomes current I sin (90-Θ5). That is, a loss equivalent to the shift by angle Θ5, which is larger than angle Θ3, occurs in the torque of the motor rotor.

As described above, in the standard method, the timing of starting the acquisition of the angular position is fixed to the timing of the start of the period of the PWM carrier signal. Therefore, a shift is likely to occur between the acquired angular position and the actual angular position at the time of performing the current control computation. Furthermore, the later the motor is in the order of current control computation, the lower the accuracy of current control for that motor. Consequently, the greater the number of motors controlled by the MCU, the larger the decrease in the accuracy of current control, and the more unstable the motor operation tends to become.

Next, referring to the lower part of FIG. 11, the case of the proposed method will be considered. First, the first motor will be focused on. The direction of the actual magnetic flux Φ of the motor rotor at the time of performing the current control computation corresponding to the first motor is shifted by an angle Θᵢₙₜₑᵣᵥₐₗ relative to the direction of the acquired angular position θ1(n−1) of the motor rotor. The shift by angle Θᵢₙₜₑᵣᵥₐₗ is caused by the rotation of motor rotor during the elapsed time which is the sum of the time required for acquiring the angular position and the time from the acquisition of the angular position to the start of the current control computation. The timing when the acquisition of the angular position is started is the timing when the previous current control computation is performed. This timing of performing the current control computation is, for example, the timing when the computation using the angular position θ1(n−2) whose acquisition is started in the previous period n−2 ends.

In the current control computation corresponding to the first motor, the acquired angular position θ1(n−1) is used instead of the angular position representing the actual direction of the motor rotor (direction of magnetic flux Φ). In this current control computation, the PWM duty ratio is calculated such that current I flows in a direction orthogonal to the direction of the angular position θ1(n−1), that is, in a direction rotated by 90-Θᵢₙₜₑᵣᵥₐₗ degrees from the direction of magnetic flux Φ. Therefore, the current component flowing in the direction orthogonal to the direction of actual magnetic flux Φ becomes current I sin (90-Θᵢₙₜₑᵣᵥₐₗ). In other words, a loss equivalent to the shift by angle Θᵢₙₜₑᵣᵥₐₗ occurs in the torque of the motor rotor.

Next, the third motor will be focused on. The direction of the actual magnetic flux Φ of the motor rotor at the time of performing the current control computation corresponding to the third motor is shifted by an angle Θᵢₙₜₑᵣᵥₐₗ relative to the direction of the acquired angular position θ3(n−1) of the motor rotor. In the proposed method, the timing when the acquisition of the angular position is started is set to the timing of performing the current control computation in the previous period n−2. Therefore, the shifted angle from the angular position θ3(n−1) to the direction of magnetic flux Φ is the angle Θᵢₙₜₑᵣᵥₐₗ as in the case of the first motor.

In the current control computation corresponding to the third motor, the PWM duty ratio is calculated such that current I flows in a direction orthogonal to the direction of the acquired angular position θ3(n−1), that is, in a direction rotated by 90-Θᵢₙₜₑᵣᵥₐₗ degrees from the direction of magnetic flux Φ. Therefore, the current component flowing in the direction orthogonal to the direction of actual magnetic flux Φ becomes current I sin (90-Θᵢₙₜₑᵣᵥₐₗ). In other words, a loss equivalent to the shift by angle Θᵢₙₜₑᵣᵥₐₗ occurs in the torque of the motor rotor as in the case of the first motor.

Next, the fifth motor will be focused on. The direction of the actual magnetic flux Φ of the motor rotor at the time of performing the current control computation corresponding to the fifth motor is shifted by an angle Θᵢₙₜₑᵣᵥₐₗ relative to the direction of the acquired angular position θ5(n−1) of the motor rotor. In the proposed method, the timing when the acquisition of the angular position is started is set to the timing of performing the current control computation in the previous period n−2. Therefore, the shifted angle from the angular position θ5(n−1) to the direction of magnetic flux Φ is the angle Θᵢₙₜₑᵣᵥₐₗ as in the cases of the first and third motors.

In the current control computation corresponding to the fifth motor, the PWM duty ratio is calculated such that current I flows in a direction orthogonal to the direction of the acquired angular position θ5(n−1), that is, in a direction rotated by 90-Θᵢₙₜₑᵣᵥₐₗ degrees from the direction of magnetic flux Φ. Therefore, the current component flowing in the direction orthogonal to the direction of actual magnetic flux Φ becomes current I sin (90-Θᵢₙₜₑᵣᵥₐₗ). In other words, a loss equivalent to the shift by angle Θᵢₙₜₑᵣᵥₐₗ occurs in the torque of the motor rotor as in the cases of the first and third motors.

As described above, in the proposed method, the timing when the acquisition of the angular position is started is set to the timing of performing the current control computation corresponding to the respective motors. Therefore, the time Tᵢₙₜₑᵣᵥₐₗ from the acquisition of the angular position to the start of the current control computation can be kept constant. As a result, the loss occurring in the torque of each motor rotor is a loss equivalent to the shift by angle Θᵢₙₜₑᵣᵥₐₗ regardless of the order in which the current control computation is performed. In other words, the amount of shifted angle is not accumulated. Consequently, even if current control for multiple motors is performed with one MCU, the torque loss of each motor rotor can be suppressed within a certain level.

Furthermore, in the proposed method, as compared with the standard method, the shift between the acquired angular position and the actual angular position at the time of performing the current control computation is smaller. Further, this characteristic does not change depending on the number of motors controlled by the MCU. Therefore, even if the number of motors controlled by one MCU increases, the decrease in accuracy of current control can be suppressed, and motor operation can be made more stable.

### Modification of Embodiment

A modification of the embodiment will be described.

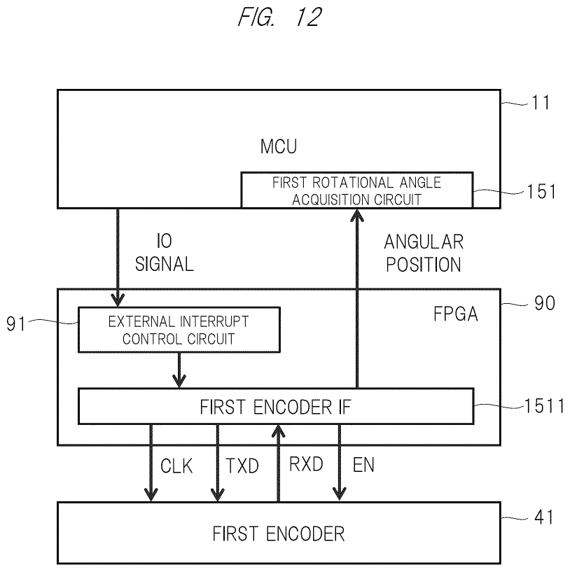

FIG. 12 is a diagram illustrating a modification of the embodiment. In this modification of the embodiment, as illustrated in FIG. 12, the first encoder IF 1511 is provided outside the MCU 10 instead of providing it inside the MCU 10. In the example illustrated in FIG. 12, an FPGA (Field Programmable Gate Array) 90 is connected between the MCU 10 and the first encoder 41. The FPGA 90 includes an external interrupt control circuit 91 and the first encoder IF 1511. A CLK (clock) signal line, a TXD (transmit data) signal line, an RXD (receive data) signal line, and an EN (enable) signal line are disposed between the first encoder 41 and the first encoder IF 1511.

When detecting the angular position θ1, the MCU 10 outputs an IO signal to the external interrupt control circuit 91 in order to perform a software interrupt. Upon receiving the IO signal, the external interrupt control circuit 91 requests the first encoder IF 1511 to transmit a signal capable of specifying the angular position θ1 from the first encoder 41. Based on this request, the first encoder IF 1511 communicates with the first encoder 41 and causes the first encoder 41 to transmit the signal capable of specifying the angular position θ1. The first encoder IF 1511 acquires the angular position θ1 from the transmitted signal and sends it to the MCU 10. The first rotational angle acquisition circuit 151 in the MCU 10 acquires the angular position θ1.

Note that the FPGA 90 is an example of a logic circuit device and may be replaced by other logic circuit devices. For example, another programmable semiconductor device may be used instead of the FPGA 90. A PLD (Programmable Logic Device), a CPLD (Complex Programmable Logic Device), or the like may be used instead of the FPGA 90. Alternatively, an ASIC (Application Specific Integrated Circuit) may be used instead of the FPGA 90.

According to this modification of the embodiment, the encoder IF is provided outside the MPU, and the MCU acquires signals from the encoder via the encoder IF. As a result, the configuration of the MCU can be simplified, in particular, the number of terminals can be reduced, and the manufacturing cost of the MCU can be reduced. Furthermore, by separating the encoder IF from the MCU and configuring it with a programmable device, an encoder IF with characteristics or performance desired by a user can be used. The desired characteristics or performance include, for example, performance capable of higher-speed data transmission.

Here, one of problems and the present embodiment and a modification thereof to be the solution of the problem will be summarized. When controlling multiple motors using one MCU, if communication with the encoder is started in synchronization with the trough of the waveform representing the PWM counter value, the torque of motors for which current control computations are performed later will decrease. Due to this influence, a decrease in control performance may occur in applications in which control of multiple motors is required. Here, by starting the communication with the encoder by using the current control computation as a trigger as in the proposed method, the time from the acquisition of the angular position of the motor rotor to the start of the current control computation can be kept constant. As a result, the reduction in torque of motors for which current control computation is performed later can be suppressed. According to the present embodiment and a modification thereof, it is possible to suppress a decrease in control performance of applications in which control of multiple motors is required.

The invention made by the present inventor has been specifically described above based on embodiments. However, it goes without saying that the present invention is not limited to the above-described embodiments and can be modified in various ways within the range not departing from the gist thereof.

For example, a robot includes a plurality of rotation mechanisms, opening/closing mechanisms, and the like, and many motors are used in these mechanisms. Robots are, for example, industrial robots, humanoid robots, exploration robots, and rescue robots. Therefore, the MCU according to the above embodiment is suitable for controlling a plurality of motors included in a robot.

What is claimed is:

1. A semiconductor device comprising:
a first AD converter;
a first rotational angle acquisition circuit;
a first PWM timer; and
a processor,
wherein the first AD converter detects a first current value supplied from a first inverter to a first motor,
wherein the first rotational angle acquisition circuit acquires a first angular position of a rotor of the first motor from a first encoder electrically connected to the first motor,
wherein the processor generates a first current control signal by performing a first computation based on the first current value detected by the first AD converter and a first angular position acquired most recently,
wherein the first PWM timer includes a first counter, and the first PWM timer generates a first PWM signal using a modulated wave based on the first current control signal and a first carrier signal defined by a value of the first counter, and then outputs the first PWM signal to the first inverter, and
wherein the processor performs, in one period of the first carrier signal,
(a) processing to cause the first AD converter to start detection of the first current value;
(b) processing to start the first computation in response to an end of the detection of the first current value; and
(c) processing to cause the first rotational angle acquisition circuit to start acquisition of the first angular position in response to the execution of the first computation.

2. The semiconductor device according to claim 1, further comprising:
a second AD converter;
a second rotational angle acquisition circuit; and
a second PWM timer,
wherein the second AD converter detects a second current value supplied from a second inverter to a second motor,
wherein the second rotational angle acquisition circuit acquires a second angular position of a rotor of the second motor from a second encoder electrically connected to the second motor,
wherein the processor generates a second current control signal by performing a second computation based on the second current value detected by the second AD converter and a second angular position acquired most recently,
wherein the second PWM timer includes a second counter, and the second PWM timer generates a second PWM signal using a modulated wave based on the second current control signal and a second carrier signal defined by a value of the second counter, and then outputs the second PWM signal to the second inverter,
wherein the processor further performs, in one period of the second carrier signal,
(d) processing to cause the second AD converter to start detection of the second current value;
(e) processing to start the second computation in response to an end of the detection of the second current value; and
(f) processing to cause the second rotational angle acquisition circuit to start acquisition of the second angular position in response to the execution of the second computation, and
wherein the processing (f) is performed after the processing (c) ends.

3. The semiconductor device according to claim 2,
wherein the processing (c) is processing to cause the first rotational angle acquisition circuit to start the acquisition of the first angular position in response to an end of the computation using the first angular position acquired most recently, and
wherein the processing (f) is processing to cause the second rotational angle acquisition circuit to start the acquisition of the second angular position in response to an end of the computation using the second angular position acquired most recently.

4. The semiconductor device according to claim 1,
wherein the processing (c) is processing to cause the first rotational angle acquisition circuit to start the acquisition of the first angular position in response to an end of the computation using the first angular position acquired most recently.

5. The semiconductor device according to claim 1,
wherein the first inverter and the first motor are of a three-phase AC type,
wherein the first current value includes current values of respective phases, and
wherein the first current control signal and the first PWM signal each include signals of respective phases.

6. The semiconductor device according to claim 1,
wherein a time required to acquire the first angular position is longer than a time required for the first computation.

7. The semiconductor device according to claim 1,
wherein a time of the one period of the carrier signal is longer than a time required to acquire the first angular position.

8. The semiconductor device according to claim 1,
wherein the first rotational angle acquisition circuit includes a first encoder interface.

9. The semiconductor device according to claim 1,
wherein the first rotational angle acquisition circuit acquires the first angular position via an external encoder interface.

10. The semiconductor device according to claim 2,
wherein the processor performs the processing (a) to (f) in accordance with a program stored in a non-volatile memory electrically connected to the processor.

11. The semiconductor device according to claim 10,
wherein the non-volatile memory is provided inside the semiconductor device.

12. A semiconductor device comprising:
N sets, each set including an AD converter, a rotational angle acquisition circuit, and a PWM timer, where N is 3 or more; and
a processor,
wherein each of the N sets corresponds to a respective one of N inverters and a respective one of N motors,
wherein the AD converter detects a current value supplied from a corresponding inverter to a corresponding motor,
wherein the rotational angle acquisition circuit acquires an angular position of a rotor of a corresponding motor from an encoder electrically connected to the corresponding motor,
wherein the processor generates a current control signal by performing a computation based on the current value detected by the AD converter and an angular position acquired most recently,
wherein the PWM timer includes a counter, and the PWM timer generates a PWM signal using a modulated wave based on the current control signal and a carrier signal defined by a value of the counter, and then outputs the PWM signal to the inverter,
wherein the processor performs, in one period of the carrier signal,
(g) processing to cause the N AD converters to start detection of the current values supplied to the N motors;
(h) processing to start the computation corresponding to a first motor in response to an end of the detection of the current values supplied to the N motors; and
(i) processing to cause a first rotational angle acquisition circuit to start acquisition of the angular position from an encoder electrically connected to the first motor in response to execution of the computation corresponding to the first motor, and
wherein the processor repeatedly performs, in the one period and with k changing from 1 to N−1 in increments of 1,
(j) processing to start the computation corresponding to a (k+1)-th motor in response to an end of the computation corresponding to a k-th motor; and
(k) processing to cause a (k+1)-th rotational angle acquisition circuit to start acquisition of the angular position from a (k+1)-th encoder in response to the execution of the computation corresponding to the (k+1)-th motor.

13. The semiconductor device according to claim 12,
wherein the processing (i) is processing to cause the first rotational angle acquisition circuit to start acquisition of an angular position corresponding to the first motor in response to an end of computation using an angular position corresponding to the first motor acquired most recently, and
wherein the processing (k) is processing to cause the (k+1)-th rotational angle acquisition circuit to start acquisition of an angular position corresponding to the (k+1)-th motor in response to an end of computation using an angular position corresponding to the (k+1)-th motor acquired most recently.

14. The semiconductor device according to claim 12,
wherein the N motors are included in a robot.
